(19) United States
(12) Patent Application Publication
(10) Pub. No.: US 2007/0166039 A1
(43) Pub. Date: Jul. 19, 2007

(54) Integrated optical transmitter

(76) Inventors: Robert Spagnoletti, Hertford (GB); James Whiteaway, Sawbridgeworth (GB)

Correspondence Address: BARNES & THORNBURG LLP, P.O. BOX 2786, CHICAGO, IL, 60690-2786, US

(21) Appl. No.: 11/327,020

(22) Filed: Jan. 6, 2006

(51) Int. Cl. H04J 14/02

(52) U.S. Cl. 398/85

(57) ABSTRACT

A wavelength division multiplex integrated optical transmitter and optical transmission system employing narrow band filters to dramatically improve tolerance to chromatic dispersion and thereby enable increased reach and/or data rates and a method of offering a communication service using such a transmitter or system.

### FIELD OF THE INVENTION

The present invention relates to a method and apparatus for communicating over an optical fibre with significant chromatic dispersion using an integrated transmitter and a system incorporating the same. In particular, but not exclusively, the present invention relates to a wavelength division multiplex integrated optical transmitter, a method of transmitting using such a transmitter and a system incorporating the same.

### BACKGROUND TO THE INVENTION

The directly modulated semiconductor laser is the source of choice for many fibre optic communication systems because it is physically small and the performance is good enough. However it can suffer from performance penalties when used at high modulation speeds on fibre with chromatic dispersion. The penalty comes from the inherent change of laser wavelength as the modulation current changes, this is often described as “chirp”. The dispersive fibre propagates the different wavelengths at different speeds, resulting in spreading out in time of a pulse which contains a range of wavelengths. As the pulses spread out in time the will overlap with each other, this phenomenon is known as inter symbol interference (ISI) and makes it more difficult to interpret the pulses. Dispersion penalty is the term often used to describe the effect of ISI as a result of dispersion.

A way of reducing this dispersion penalty is to use the laser to provide a continuous optical output, at a fixed wavelength, and pass this through an additional modulator to modulate data onto the optical carrier. This results in a narrower optical spectrum than from a directly modulated laser. Electro absorption modulators can be made from compound semiconductor materials and these can be integrated, either monolithically or as a hybrid, with a laser to produce a lower chirp optical source for high speed fibre links.

A second class of modulator is based on a Mach Zhender interferometer fabricated in an electro optic material where the phase delay on the two paths can be controlled by an electric field. When made in Lithium Niobate these devices can produce negatively chirped pulses, positively chirped pulses or unchirped pulses depending on the electrical drive arrangements to the individual optical paths. These modulators are the choice where ultimate performance is desired but they tend to be bulky when compared with a direct modulated laser and they require more electrical drive voltage.

All of the above modulator options result in a modulated optical spectrum containing a carrier and upper and lower sidebands. In the chirped cases there is both amplitude and angle modulation of the optical carrier. Most optical receivers rely on a PIN diode or an Avalanche Photo Diode (APD) to detect the intensity of the received optical light, such detectors are not sensitive to the phase of the optical signal. In signal processing terms the act of detection folds the optical spectrum about the carrier and adds the upper and lower sidebands together to give the baseband signal. When the optical signal is dispersed by the fibre this results in a frequency dependant phase shift across the optical spectrum. When this phase shifted spectrum is folded about the carrier there can be sideband frequency components where the upper sideband and lower sideband have exactly a pi phase shift between them resulting in signal cancellation.

A common technique to overcome dispersion in long reach, high capacity, optically amplified systems is to use dispersion compensation fibre (DCF), that is to say fibre with the opposite sign of sign dispersion, which cancels the dispersion of the transmission fibre. This has a number of unwanted consequences. The amplifiers required to overcome the loss of the dispersion compensating fibre add noise to the system. The dispersion compensating fibre needs to be placed optimally along the length of the system, complicating installation and management. Changes to the system fibre can require changes to the location and amount of dispersion compensating fibre.

Dispersion compensating fibre is commonly used at 10 Gbit/s today. Earlier systems that were primarily designed for 2.5 Gbit/s operation may not use DCF. There is commercial interest in upgrading some or all of the wavelengths on these systems from 2.5 Gbit/s to 10 Gbit/s. It would be very desirable to do this without resort to more amplifiers and DCF.

Recent advances in the processing of compound semiconductors, typically using III/V materials and multi-quantum well (MQW) structures, has resulted in the ability to monolithically integrate a number of different structures on the same substrate. By tailoring the bandgap of the MQW layers it is possible to make lasers, modulators and passive waveguides on the same substrate. A number of organisations have successfully integrated arrays of lasers and a wavelength selective combining device on the same substrate.

Such devices would appear to be ideal sources for WDM transmission systems, however, as discussed above, directly modulated lasers usually suffer from a dispersion penalty as a result of chirp. This can be partially overcome by using the laser as a CW source and modulating it with an additional device, for example an electro absorption modulator. This improves the transmission performance but reduces the optical output power of the device as a result of the optical loss of the modulator. Additionally it increases the thermal dissipation of the device, negating the benefits of integration.

### OBJECT TO THE INVENTION

The invention seeks to provide an improved method and apparatus for generating a wavelength division multiplex signal with a compact and inexpensive device.

### SUMMARY OF THE INVENTION

According to one aspect of the present invention, there is provided a wavelength division multiplex transmitter array and multiplexer comprising:
a plurality of semiconductor lasers, each laser being arranged to output at a different central optical wavelength;
a wavelength selective device arranged to combine the outputs of the lasers; and
a corresponding plurality of narrow band optical filters, each filter being coupled to a respective laser and having a band center wavelength offset from the central optical wavelength of the respective laser.

In one embodiment, the wavelength selective device provides the corresponding plurality of narrow band optical filters.

In one embodiment, the lasers are integrated onto a single substrate.

In another embodiment, the lasers and the wavelength selective device are integrated onto a single substrate.

In one embodiment, the wavelength selective device comprises a plurality of narrow band optical filters each arranged to reduce a phase difference between FM and AM of the modulated optical signal, and each having a bandwidth sufficiently narrow to substantially remove damped oscillatory transients in frequency that fall outside the spectrum of adiabatic frequency chirp resulting from the modulation, combined with Fourier broadening caused by transmitted data.

In one embodiment, the bandwidths of the narrow band filters are narrower than the spectrum of adiabatic frequency chirp resulting from the modulation, combined with Fourier broadening caused by transmitted data.

In one embodiment, the filters are arranged to pass wavelengths at one side of the central optical wavelength.

In one embodiment, the lasers are directly modulated lasers.

There is also provided a method of offering a communication service over an optical communication system having a wavelength division multiplex transmitter array and multiplexer according to the above aspect.

There is also provided an optical data transmission system having a wavelength division multiplex transmitter array and multiplexer according the above aspect

According to another aspect of the present invention, there is provided wavelength division multiplex transmitter array and multiplexer comprising:
an array of semiconductor lasers, each laser being arranged to output at a different wavelength;
a wavelength selective device arranged to combine the outputs of the lasers
a control system to maintain the wavelengths of the individual lasers such that under high speed modulation a significant amount of the laser's output spectrum does not pass through the wavelength selective device to the main output.

According to another aspect of the present invention, there is provided optical transmission system comprising:
a wavelength division multiplex transmitter array and multiplexer comprising a plurality of semiconductor lasers, each laser being arranged to output at a different central optical wavelength, and a wavelength selective device arranged to combine the outputs of the lasers; and
a corresponding plurality of narrow band optical filters, each filter being coupled to a respective laser and having a band center wavelength offset from the central optical wavelength of the respective laser.

In one embodiment, the plurality of narrow band optical filters is located at a receiver of the optical transmission system.

There is also provided a method of offering a communication service over an optical communication system having a wavelength division multiplex transmitter array and multiplexer according to the above aspect.

Advantageously, the present invention enables compact and inexpensive WDM transmitters and transmission systems to be developed which ameliorate the dispersion penalties associated with the above described prior art approaches and enable increased reach and/or data rates.

The invention is also directed to a method by which the described apparatus operates and including method steps for carrying out every function of the apparatus.

The invention also provides for a system for the purposes of communications which comprises one or more instances of apparatus embodying the present invention, together with other additional apparatus.

The preferred features may be combined as appropriate, as would be apparent to a skilled person, and may be combined with any of the aspects of the invention.

In order to show how the invention may be carried into effect, embodiments of the invention are now described below by way of example only and with reference to the accompanying figures in which:

### BRIEF DESCRIPTION OF THE DRAWINGS

FIG. 1 shows an optical transmitter according to the present invention comprising an array of lasers and a wavelength selective combining function;

FIG. 2 shows an optical transmitter apparatus according to the present invention comprising the optical transmitter of FIG. 1 and associated control function; and

FIG. 3 shows the optical spectrum relating to one modulated laser in the array.

### DETAILED DESCRIPTION OF INVENTION

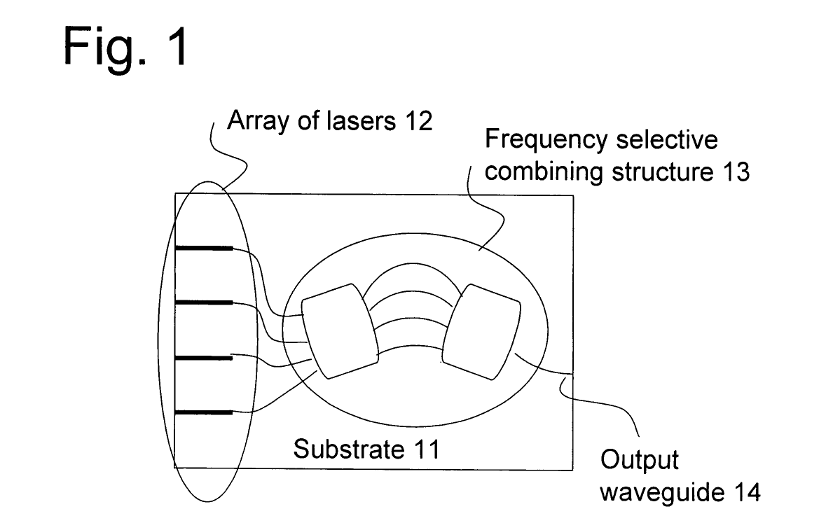

In FIG. 1, a substrate 11 comprises an array of lasers 12 each of which is coupled to a wavelength selective combining structure 13 which is coupled to an output waveguide 14. The wavelength selective combining structure 13 may be an Arrayed Waveguide Grating (AWG). Each laser in the array can be independently modulated. This modulation could alter the output power of the laser or its wavelength, typically it will alter both. The control and drive electronics provides the necessary bias and data modulation current to each laser in the array.

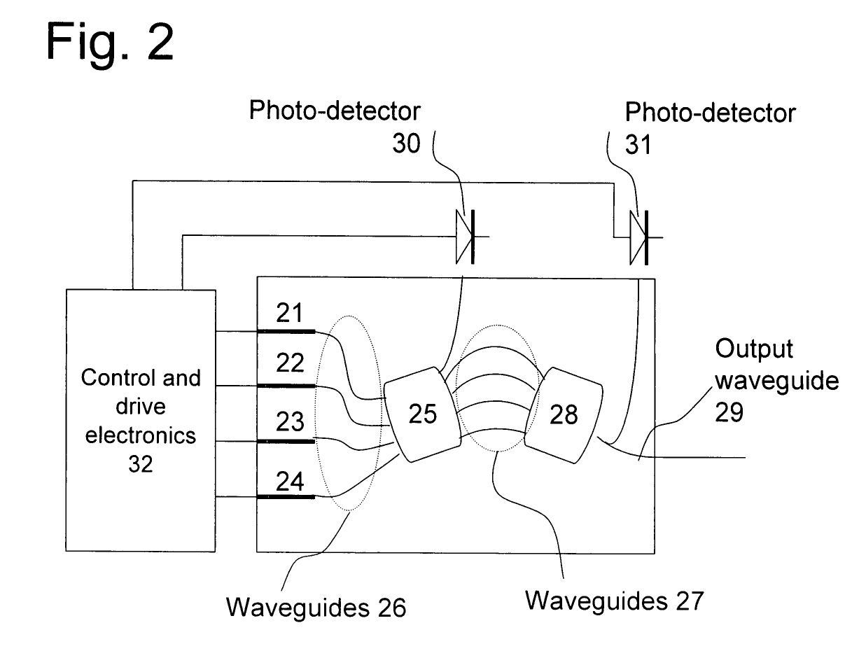

As shown in FIG. 2, each laser, 21 through 24, in the array is designed to operate at the wavelength appropriate to its position in the array, such that its output can be coupled through the wavelength selective structure to the output waveguide. Electrical connections to the laser array may be used to allow independent fine tuning of each laser. There may be additional connections to heating element(s) local to each laser if this is the method chosen to adjust the laser wavelength. Each laser is coupled to the first radiative region 25 of the AWG structure by a waveguide 26. The first and second radiative regions are coupled with an array of waveguides 27 of different lengths, chosen to achieve the filter's transmission characteristic. The second radiative region 28 is also coupled to the output waveguide 29. FIG. 2 shows 4 lasers in the array by way of illustration, other numbers of lasers can also be used.

The wavelength selective combining element in the preferred embodiment above is based on the AWG, however other structures are also possible, for example an echelle grating could be used as the diffractive element in the wavelength selective structure.

Power monitoring functions are provided to enable the wavelength of each individual laser to be adjusted to match the characteristics of the filter. In the preferred embodiment this is achieved by monitoring a proportion of the power in the first radiative region with photo-detector 30 and also a proportion the power in the output waveguide with photo-detector 31. The ratio of the power from each laser that is detected in the first radiative region and the power detected in the output waveguide allows the lasers wavelength to be determined in relation to the filter's characteristics. A monitoring tone of different frequency is applied to each laser so that each laser's contribution to the detected power at the photodiode can be uniquely determined and processed by the control electronics 32. Photodiodes 30 and 31 may be integrated on the substrate or coupled to it by other means.

In a preferred embodiment, the wavelength selective combining structure 13 functions as a array of optical filters. The exact wavelength of operation of the filters will typically dependent on the process run and the temperature of operation. The temperature can be used to position the filter characteristics optimally with respect to the ITU grid. The wavelengths of the individual lasers are controlled by the control electronics to ensure that they are optimally placed in relation to the filter characteristics.

Processing variability could result in lasers that are so far away from the desired operating wavelength that the tuning mechanisms are unable to get them to the target value. This is solved by making additional lasers at each end of the array and selecting the subset of lasers that most accurately meet the wavelength specification.

Controlling an individual laser's wavelength can be accomplishes in a number of ways including but not limited to control of the mean current through the laser, controlling the local temperature of the laser stripe using a heater, an additional section within the laser cavity or combinations of techniques.

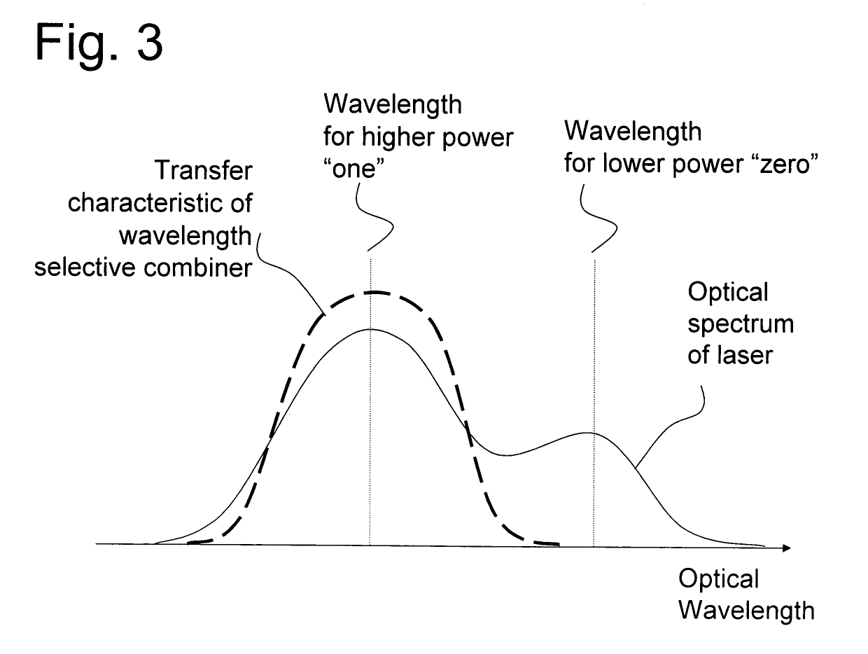

In a preferred embodiment, the data is transmitted as binary where logic “one” corresponds to a higher power and logic “zero” corresponds to a lower power level. The power levels also correspond to different optical wavelengths as shown in FIG. 3. The mean laser wavelength is adjusted by the control and drive electronics such that the power corresponding to logic “one” passes through the wavelength selective combiner 13 and power corresponding to logic “zero” is mainly rejected and not coupled into the output waveguide. This is achieved by arranging the array of filters of wavelength selective combiner 13 to be of narrow bandwidth and to have a band center frequency (ie wavelength) offset from a central optical frequency (ie wavelength) of the optical signal as described in co-pending unpublished U.S. patent application Ser. No. 10/859,406, filed Jun. 2, 2004 and assigned to Nortel Networks Ltd., the disclosure of which is hereby incorporated by reference in its entirety.

As described in U.S. patent application Ser. No. 10/859,406 the significant improvements in data rates and reach of optical transmission systems may be achieved by using a narrowband optical filter either at the receiver end or at the transmitter end. In the preferred embodiment of the present invention, the wavelength selective combiner 13 at the transmitter end functions as a plurality of narrowband optical filters. However, in other embodiments, the filters may be provided in a separate module locally coupled to the optical transmitter or indeed employed at the receiver-end of the optical transmission system.

Narrowband optical filtering can give rise to inter symbol interference, however the resulting penalty can be partially recovered with signal processing after the optical detector at the receive end of the transmission link. Signal processing techniques could include but are not limited to decision feedback equalisation (DFE), feed forward equalisation (FFE), maximum likelihood sequence estimation (MLSE) and forward error correction (FEC).

Any range or device value given herein may be extended or altered without losing the effect sought, as will be apparent to the skilled person for an understanding of the teachings herein.

1. A wavelength division multiplex transmitter array and multiplexer comprising:
a plurality of semiconductor lasers, each laser being arranged to output at a different central optical wavelength;
a wavelength selective device arranged to combine the outputs of the lasers; and
a corresponding plurality of narrow band optical filters, each filter being coupled to a respective laser and having a band center wavelength offset from the central optical wavelength of the respective laser.

2. A wavelength division multiplex transmitter array and multiplexer according to claim 1, wherein the wavelength selective device provides the corresponding plurality of narrow band optical filters.

3. A wavelength division multiplex transmitter array and multiplexer according to claim 1, wherein the lasers are integrated onto a single substrate.

4. A wavelength division multiplex transmitter array and multiplexer according to claim 1, wherein the lasers and the wavelength selective device are integrated onto a single substrate.

5. The wavelength division multiplex transmitter array and multiplexer of claim 1, wherein the wavelength selective device comprises a plurality of narrow band optical filters each arranged to reduce a phase difference between FM and AM of the modulated optical signal, and each having a bandwidth sufficiently narrow to substantially remove damped oscillatory transients in frequency that fall outside the spectrum of adiabatic frequency chirp resulting from the modulation, combined with Fourier broadening caused by transmitted data.

6. The wavelength division multiplex transmitter array and multiplexer of claim 1, wherein the bandwidths of the narrow band filters being narrower than the spectrum of adiabatic frequency chirp resulting from the modulation, combined with Fourier broadening caused by transmitted data.

7. The wavelength division multiplex transmitter array and multiplexer of claim 1, wherein the filters are arranged to pass wavelengths at one side of the central optical wavelength.

8. The wavelength division multiplex transmitter array and multiplexer of claim 1, wherein the lasers are directly modulated lasers.

9. A method of offering a communication service over an optical communication system having a wavelength division multiplex transmitter array and multiplexer according to claim 1.

10. An optical data transmission system having a wavelength division multiplex transmitter array and multiplexer according to claim 1.

11. A wavelength division multiplex transmitter array and multiplexer comprising:
an array of semiconductor lasers, each laser being arranged to output at a different wavelength;
a wavelength selective device arranged to combine the outputs of the lasers
a control system to maintain the wavelengths of the individual lasers such that under high speed modulation a significant amount of the laser's output spectrum does not pass through the wavelength selective device to the main output.

12. An optical transmission system comprising:
a wavelength division multiplex transmitter array and multiplexer comprising a plurality of semiconductor lasers, each laser being arranged to output at a different central optical wavelength, and a wavelength selective device arranged to combine the outputs of the lasers; and
a corresponding plurality of narrow band optical filters, each filter being coupled to a respective laser and having a band center wavelength offset from the central optical wavelength of the respective laser.

13. An optical transmission system according to claim 12, wherein the plurality of narrow band optical filters is located at a receiver of the optical transmission system.

14. A method of offering a communication service over an optical communication system according to claim 12.
